(19) United States
(12) Patent Application Publication
(10) Pub. No.: US 2009/0194401 A1
(43) Pub. Date: Aug. 6, 2009

(54) LIGHT EMITTING KEYPAD

(76) Inventor: Hyun Soo Kim, Gyeonggi-do (KR)

Correspondence Address: WILSON & HAM, 2530 BERRYESSA ROAD, PMB: 348, SAN JOSE, CA, 95132, US

(21) Appl. No.: 12/299,728

(22) PCT Filed: Nov. 6, 2007
(86) PCT No.: PCT/KR2006/004598

§ 371 Date: Nov. 5, 2008

(30) Foreign Application Priority Data
May 15, 2006 (KR) 10-2006-0043564

(51) Int. Cl. H01H 9/00

(52) U.S. Cl. 200/314

(57) ABSTRACT

The present invention provides a light emitting keypad, which can obtain a more uniform light emitting surface and the same effects as or superior effects to conventional light emitting keypads even though a small number of light sources are used as compared with the conventional light emitting keypads, by causing light emitted from light sources arranged in a top view type through a light guide film to be incident into the light guide film and by emitting the light to the outside through the light guide film.

### TECHNICAL FIELD

The present invention relates to a light emitting keypad.

### BACKGROUND ART

In general, a light emitting keypad is applied to communication equipment such as a mobile phone so that the light emitting keypad is used as a switch device for generating a signal or performing various additional functions. The light emitting keypad has the function of enabling identification of numeral or character keys in the nighttime or at a dark place. Recently, an ultra-thin light emitting keypad has been developed and employed as mobile phones become thinner.

FIG. 1 is a sectional view of a conventional direct illumination type LED(Light Emitting Diode) keypad that comprises a printed circuit board (100), domes (102), direct illuminating LEDs (103), and a keypad portion (104). The printed circuit board (100) has contact terminals (101). Here, the plurality of domes and direct illuminating LEDs are installed on a front surface of the printed circuit board. The keypad portion that has numerals or characters printed on an upper surface thereof and protrusions (105) formed on a lower surface thereof is installed in front of the domes and the direct illuminating LEDs.

In this direct illumination type LED keypad, the keypad portion is illuminated by light emitted from the direct illuminating LEDs installed on the front surface of the printed circuit board. That is, when a user presses a key of the keypad portion, a protrusion corresponding to the key of the keypad portion allows a corresponding dome to be connected to a corresponding contact terminal of the printed circuit board to generate a predetermined electrical signal. The generated electrical signal causes a corresponding LED to emit light so that the keypad portion can be directly illuminated by the LED in the form of a point light source.

However, the aforementioned direct illumination type LED keypad is manufactured to be relatively thicker since it is impossible to fabricate a thin keypad due to characteristics of the LEDs. Furthermore, the direct illumination type LED keypad may reduce a use time of a battery since power consumption increases according to light emission of the LEDs. Furthermore, there is difficulty in designing the direct illumination type LED keypad since light emission uniformity may be irregular in accordance with the arrangement positions of the LEDs.

FIG. 2 is a sectional view of a conventional EL(Electroluminiscence) type light emitting keypad for solving the aforementioned problems. The EL type light emitting keypad comprises key tops (110), an EL metal dome sheet (120) and a printed circuit board (130). The EL metal dome sheet (120) comprises an EL sheet (121), metal domes (123) and a base tape (122), thereby achieving ultra-slimness and low power consumption.

As for the function of this EL type metal dome keypad, when a user presses the key top (110), a protrusion (111) disposed on a back surface of the key top (110) causes the metal dome (123) to be brought into contact with a fixed contact terminal (131) of the printed circuit board (130) so that the keypad is switched on and operated.

However, in the conventional EL type light emitting keypad, there is a high risk that the EL sheet may be damaged or broken since the EL sheet (121) is consecutively pressed and impacted by the protrusion (111), and thus, a severe problem of degradation of the reliability of EL is caused and there is also a problem in that a click feeling of the keypad is deteriorated. Furthermore, the conventional EL type light emitting keypad has problems in that the EL sheet has a life span shorter than that of an LED due to characteristics of the EL sheet, noise is produced in an LCD module, and reliability is lowered. Moreover, the conventional EL type light emitting keypad has a problem in that production costs increase as compared with manufacture of an LED keypad.

Meanwhile, in case of conventional top view type light sources, they are disadvantageous in view of manufacturing processes and costs due to a large number of light sources to be used, and have a problem in that a light leakage phenomenon occurs since light emitted from the light sources is emitted directly to the outside. Therefore, there is a need for solving these problems.

### DISCLOSURE OF INVENTION

### Technical Problem

In order to solve the aforementioned problems, it may be contemplated that an indirect illumination type LED light source is prepared and an optical fiber with superior optical transmission characteristics for uniformly supplying light to a keypad is installed. However, since the optical fiber is essentially made of silicone, there are problems in that it is difficult to make the optical fiber thin, and it is difficult to actually apply the optical fiber to the keypad.

The present invention is conceived to solve the problems in the prior art. An object of the present invention is to provide a light emitting keypad, which can obtain a more uniform light emitting surface and the same effects as or superior effects to conventional light emitting keypads even though a small number of light sources are used as compared with the conventional light emitting keypads, by causing light emitted from light sources arranged in a top view type through a light guide film to be incident into the light guide film and by emitting the light to the outside through the light guide film.

Furthermore, another object of the present invention is to provide a light emitting keypad, which can prevent a light leakage phenomenon by selectively employing a coupling member such as a reflection layer to shield emission of light directly to the outside.

### Technical Solution

The present invention for achieving the object provides a light emitting keypad comprising a key plate with a plurality of keys formed thereon; a light guide film formed below the key plate so that light can be incident into and guided in the light guide film and then surface-emitted; a plurality of top view type light sources disposed below the light guide film; and a substrate disposed below the light guide film and having metal domes.

In the light emitting keypad, all or some of the light sources may have a light emission angle in a range of 60° to 180°.

In the light emitting keypad, through-holes may be formed in regions of the light guide film corresponding to light sources so that the light from the light sources can be incident into the light guide film.

In the light emitting keypad, a coupling member formed of at least one selected from a reflection layer, a translucent layer and a transparent layer may be formed above each of the through-holes of the light guide film.

In the light emitting keypad, protrusions may be formed on a bottom surface of the light guide film to correspond to the metal domes in order to press the metal domes.

In the light emitting keypad, a reflection layer capable of being in contact with or spaced apart from the light guide film may be formed on a lower portion of the light guide film.

In the light emitting keypad, the reflection layer may be formed of a reflection sheet and attached to one side end, both side ends or the entire of a back surface of the light guide film using a double-sided tape.

In the light emitting keypad, the reflection layer may comprise at least one selected from the group consisting of silver (Ag), titanium dioxide (TiO₂), zinc oxide (ZnO), barium sulfate (BaSO₄), zinc sulfide (ZnS), lead white and antimony oxide (Sb₂O₃).

In the light emitting keypad, on at least one of front and back surfaces of the light guide film, a pattern may be formed such that the pattern has a density increasing as the pattern goes far away from light sources, so as to uniformly supply light to the keypad, or patterns may be locally formed in specific regions of the light guide film so that light is intensively supplied to predetermined regions of the keypad.

In the light emitting keypad, the pattern may be formed by means of at least one processing method of hot stamping, injection molding, micro blast and laser.

In the light emitting keypad, the pattern may be formed by means of silk printing using an ink containing a light-scattering material on the light guide film.

In the light emitting keypad, the density of the pattern may be adjusted by at least one method selected from interval adjustment and size adjustment of the pattern.

In the light emitting keypad, the key plate may be a flat key plate having the keys expressed and identified with colors.

In the light emitting keypad, the reflection layer may be formed on all or a portion of an upper surface of the substrate.

Further, the present invention provides a lower structure for a light emitting keypad, comprising a substrate provided with metal domes; a plurality of top view type light sources disposed on the substrate; and a light guide film disposed above the light sources so that light can be incident into and guided in the light guide film and then surface-emitted.

### ADVANTAGEOUS EFFECTS

The present invention has the following advantages resulting from the aforementioned unique constitutions. That is, according to the light emitting keypad of the present invention, it is possible to obtain a more uniform light emitting surface and the same effects as or superior effects to conventional light emitting keypads even though a small number of light sources are used as compared with the conventional light emitting keypads, by causing light emitted from light sources arranged in a top view type through a light guide film to be incident into the light guide film and by emitting the light to the outside through the light guide film. Furthermore, it is possible to improve luminance of emitted light at the positions of keys and prevent a light leakage phenomenon, by selectively employing a coupling member such as a reflection layer to shield emission of light directly to the outside.

### BRIEF DESCRIPTION OF THE DRAWINGS

FIG. 1 is a sectional view of a conventional direct illumination type LED light emitting keypad.

FIG. 2 is a sectional view of a conventional EL type light emitting keypad.

FIGS. 3 to 6 are schematic sectional views of light emitting keypads according to embodiments of the present invention.

FIGS. 7 and 8 are sectional views of examples of a light guide film for use in the light emitting keypad of the present invention, in which a boding member and patterns are formed in the light guide film.

FIGS. 9 to 11 are plan views of examples of a light guide film for use in the light emitting keypad of the present invention, showing patterns on the light guide film.

FIG. 12 is a sectional view of a light emitting keypad according to another embodiment of the present invention.

FIG. 13 is a diagram illustrating a light emission angle of a light source in the present invention.

FIG. 14 is a partial sectional view of a light emitting keypad according to a further embodiment of the present invention.

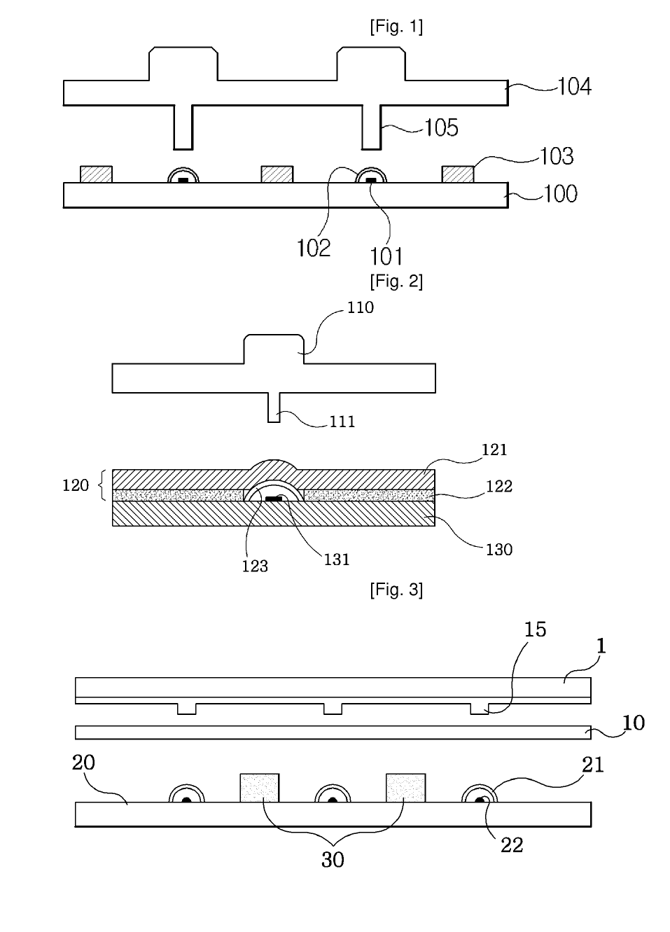

### EXPLANATION OF REFERENCE NUMERALS FOR MAIN PORTIONS IN DRAWINGS

1: Key plate 10: Light guide film
12: Lower reflection layer 13: Pattern
14: Double-sided tape 15: Protrusion
20: Circuit board 21: Metal dome
22: Contact terminal 30: Light source
40: Bonding member 41: Reflection layer
50: Reflection layer A: Light emission angle

### BEST MODE FOR CARRYING OUT THE INVENTION

Hereinafter, the present invention will be described in detail with reference to the accompanying drawings.

FIG. 3 is a sectional view of a light emitting keypad according to an embodiment of the present invention. As shown in the figure, the light emitting keypad comprises a key plate (1) with a plurality of keys formed thereon; a light guide film (10) formed below the key plate (1) so that light can be incident into and guided in the light guide film and then surface-emitted; a plurality of top view type light sources (30) disposed below the light guide film; and a substrate (22) disposed below the light guide film and having metal domes (21). Since the shapes of keys and the key plate are well known in the art, they are not shown in detail in the figure. Lower protrusions (15) are formed on a bottom surface of the key plate (1) to improve accurate manipulation and click feelings of the keys. In addition to the components listed above, other components may be added, if necessary. The addition of other components is included in the present invention.

In the light emitting keypad of the present invention, light emitted from the light sources (30) arranged in a top view type through the light guide film (10) is incident into the light guide film, and is then guided through the light guide film to other regions which the light of the light sources does not directly reach and is subsequently emitted to the outside. Thus, it is possible to obtain a more uniform light emitting surface as compared with a case where a light guide film is not used, and to obtain the same effects as or superior effects to conventional light emitting keypads even though a small number of light sources are used as compared with the conventional light emitting keypads.

The light guide film (10) is preferably made of a material that not only has a superior light guiding property and excellent moldability but also can provide accurate switching and an excellent click feeling due to its flexibility and elastic force. As results of repeated tests, it has been found that polycarbonate (PC) and polyethylene terephthalate (PET) are most preferred as the material capable of satisfying such properties. Particularly, since polycarbonate (PC) or polyethylene terephthalate (PET) has excellent flexibility, pressing of a specific key on the keypad causes flexure in only a region corresponding to the specific key so that switching can occur only in the specific key. Furthermore, since polycarbonate (PC) or polyethylene terephthalate (PET) is an elastic material, the keys of the keypad exhibit a good click feeling and can be restored back to the original state upon release of pressing on a specific key.

Although there is no particular limitation on the substrate (20), the substrate may be a printed circuit board (PCB) and have dome switches each of which comprises a metal dome (21) and a contact terminal (22). Further, the substrate may be a dome substrate on which the metal domes (21) are integrally formed. Therefore, when a user presses a key plate of the light emitting keypad, a region of the light guide film (10) to be pressed is elastically deformed so that a relevant metal dome (21) of the substrate (20) is also pressed and accordingly brought into contact with the contact terminal (22), thereby performing switching.

Although there is no particular limitation on the light source (30), an LED is most preferred. The LED is proper since it can easily realize colors and fabricated at low costs. The light source is disposed below the light guide film to emit light toward the light guide film so that the light is incident into and diffused by the light guide film and then converted into surface light which in turn is emitted to the outside. Here, a plurality of light sources are provided.

The protrusions (15) can be formed on the back surface of the key plate (1). There is no limitation on the shape and the like of the protrusions, and any projections formed to press the dome switches are included in the present invention. The provision of the protrusions (15) more improves click feelings of the keys on the keypad and enables switching in the dome switches even with a smaller force.

Although there is no limitation on the material of the protrusions (15), the protrusions (15) may be made of a material selected from silicone and a polymer resin, or the same material as the light guide film. As for a method of forming the protrusions (15), the protrusions may be formed directly on the light guide film, or formed by attaching a layer with the protrusions formed therein to the back surface of the key plate. The method of forming the protrusions includes press molding of liquid silicone or film silicone, a polymer resin, or the like at 100 to 150° C. using a mold formed to correspond to a back layer and/or the protrusions (15); photolithography; and screen printing using an UV-curing or an IR-curing ink.

The key plate (1) may be a key plate formed with convex or concave keys. Alternatively, the key plate may be a flat key plate formed with flat keys. That is, the keys may be expressed by using different colors respectively in the keys and other regions except the keys. That is, the coloring may be performed by providing a coloring layer to regions on an upper surface of the light guide film except the keys, as shown in the figure. Alternatively, the keys may be colored with a different color. Accordingly, the keys and the regions except the keys are represented and identified with different colors, so that the keys can be formed in a flat shape. In addition, various methods for representing the keys are included in the present invention. It is preferred that character or numeral keys be formed transparently or translucently so that light can be emitted to conform to the shapes of the keys.

### MODE FOR THE INVENTION

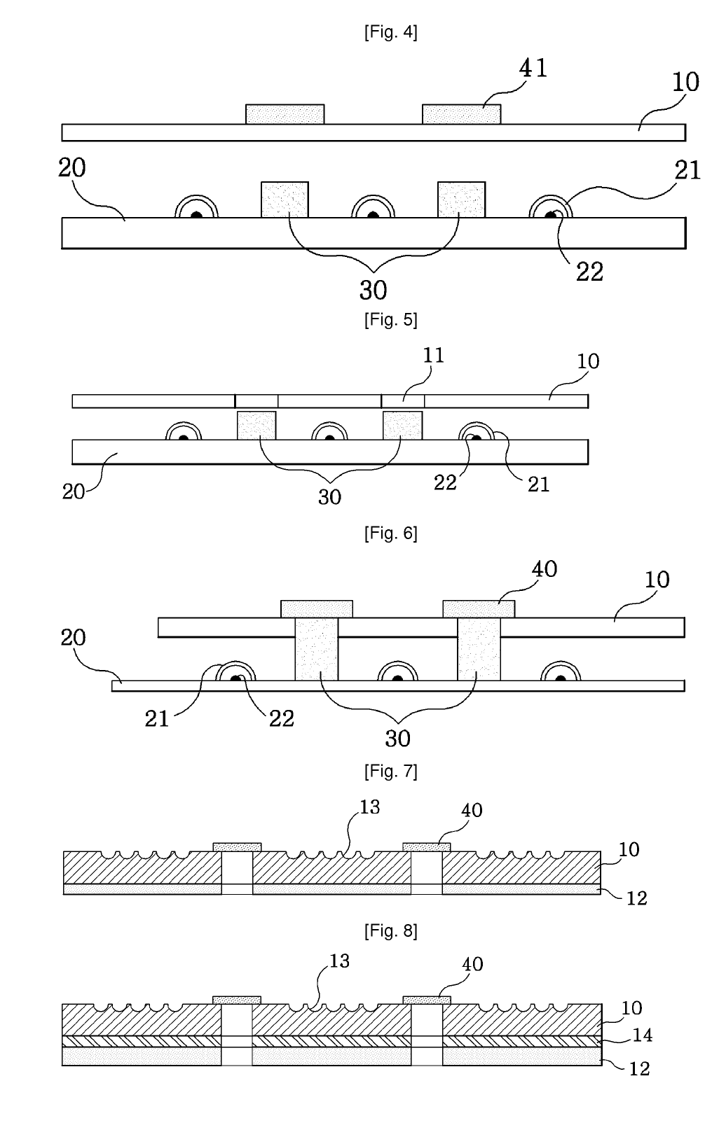

FIG. 4 is a sectional view of a light emitting keypad according to another embodiment of the present invention. As shown in the figure, reflection layers (41) capable of reflecting light can be formed on an upper surface of a light guide film (10) in correspondence with the positions of light sources (30). It is possible to obtain a light-emitting surface, which has a more uniform light distribution and high luminance, by primarily reflecting light through the reflection layers (41) and causing the light to be incident into the light guide film and subsequently to be emitted to the outside through the light guide film. Furthermore, the upper reflection layers can prevent the occurrence of a light leakage phenomenon by shielding emission of light directly to the outside.

The material of the reflection layer (41) may be selected, without limitation, from any materials so far as the materials can reflect light, wherein a white pigment and the like can be used solely or in a paste form. It is preferred that the material of the reflecti on layer be at least one selected from silver (Ag), titanium dioxide (TiO₂), zinc oxide (ZnO), barium sulfate (BaSO₄), zinc sulfide (ZnS), lead white and antimony oxide (Sb₂O₃).

The upper reflection layer may be formed on a back surface of the light guide film by a deposition method, a coating method, a printing method or the like. Since the deposition method, the coating method and the printing method are well known, detailed descriptions thereof will be omitted.

More preferably, for the sake of easiness of a process, the reflection layers (41) manufactured in a sheet form are bonded to predetermined regions of the light guide film (10) using an adhesive member such as a tape.

FIGS. 5 and 6 are sectional views of light emitting keypads according to other embodiments of the present invention. As shown in the figure, a light guide film (10) is characterized in that through-holes (11) are formed in regions of the light guide film corresponding to light sources (30) so that light from the light sources (30) can be incident into the light guide film. Additionally, a coupling member (40) that is formed of at least one selected from a reflection layer, a translucent layer and a transparent layer can be further formed above each of the through-holes of the light guide film. The light sources may be positioned adjacent to the through-holes or partially inserted into the through-holes.

Although there is no particular limitation on the light sources, it is preferred that a light emission angle (A) be between 60° and 180° as illustrated in FIG. 13. Particularly, in a case where the light sources are partially inserted into the through-holes, the light emission angle should be large in order to ensure that a greater amount of light can be incident into the light guide film.

The coupling members (40) can prevent a light leakage phenomenon that may occur when light from the light sources is emitted directly to the outside. A transparent tape can be advantageously used particularly when the positions of the light sources correspond to regions of the key plate where light is not emitted. In addition, the coupling members can perform the functions of preventing damage, which may be generated in the through-holes during key manipulation due to the small thickness of the light guide film, and supporting the light guide film.

The coupling members are formed into the aforementioned reflection layers to enhance the luminance of the light guide film. Furthermore, the coupling members may be made of a translucent material. The coupling members may be fixed by using an adhesive or may be in the form of a tape with an adhesive (sticky) layer formed thereon.

FIGS. 7 and 8 are views showing examples of a light guide film (10) for use in the light emitting keypad of the present invention. A lower reflection layer (12) can be formed on a back surface of the light guide film (10) to improve the luminance of a light-emitting surface of the keypad. The lower reflection layer is to prevent emission and disappearance of light through the back surface of the light guide film. Particularly, when the lower reflection layer and a pattern to be described later are simultaneously formed on the back surface of the light guide film, light is scattered by the pattern formed on the back surface of the light guide film and is emitted by the reflection layer toward the front of the light guide film, thereby obtaining a more uniform light emitting surface. It is preferred that the lower reflection layer be not formed in regions where the light sources are located.

The material and forming method of the aforementioned upper reflection layer can be employed as the material and forming method of the lower reflection layer (12) without limitation.

The lower reflection layer may be formed on the back surface of the light guide film by a deposition method, a coating method, a printing method or the like. Preferably, for the sake of simplification of a process, the lower reflection layer (12) manufactured in the form of a sheet is attached to the back surface of the light guide film (10) using a double-sided tape (14), as shown in FIG. 8. That is, the reflection layer is formed of a sheet containing a reflecting material and is preferably formed by being bonded to one side end, both side ends or the entire of the back surface of the light guide film using an adhesive, a double-sided tape or the like.

The lower reflection layer (12) may be in fully close contact with or spaced apart by a predetermined distance from the light guide film. A method of causing the reflection layer to be spaced apart by the predetermined distance from the light guide film can be performed by bonding the reflection layer to one side end or both side ends of the light guide film using a double-sided tape with a predetermined thickness. That is, when the reflection layer is bonded to only one side end or both side ends of the light guide film, a predetermined gap corresponding to the thickness of the double-sided tape is produced between the reflection layer and the light guide film at other portions of the light guide film except the one side end or both side ends of the light guide film.

Once the reflection layer is lengthened than the light guide film and ends of the reflection layer are then bonded to the light guide film, if necessary, the gap may be further increased as much as an excessive length of the reflection layer. Particularly, since a substrate having convexo-concave dome switches is disposed below the light guide film in case of a light emitting keypad, it is also desirable to sufficiently lengthen the reflection layer such that the reflection layer can be disposed to be in contact with the substrate having the dome switches.

The pattern (13) is formed on at least one of a front surface and a back surface (not shown) of the light guide film (10) so that light can be uniformly supplied to the keypad. Although only the formation of concave patterns on a light guide film is shown, the present invention is not limited thereto but may include the formation of convex patterns. Light is refracted and scattered by the pattern so that light can be emitted to the keypad, thereby obtaining a uniform light emitting surface.

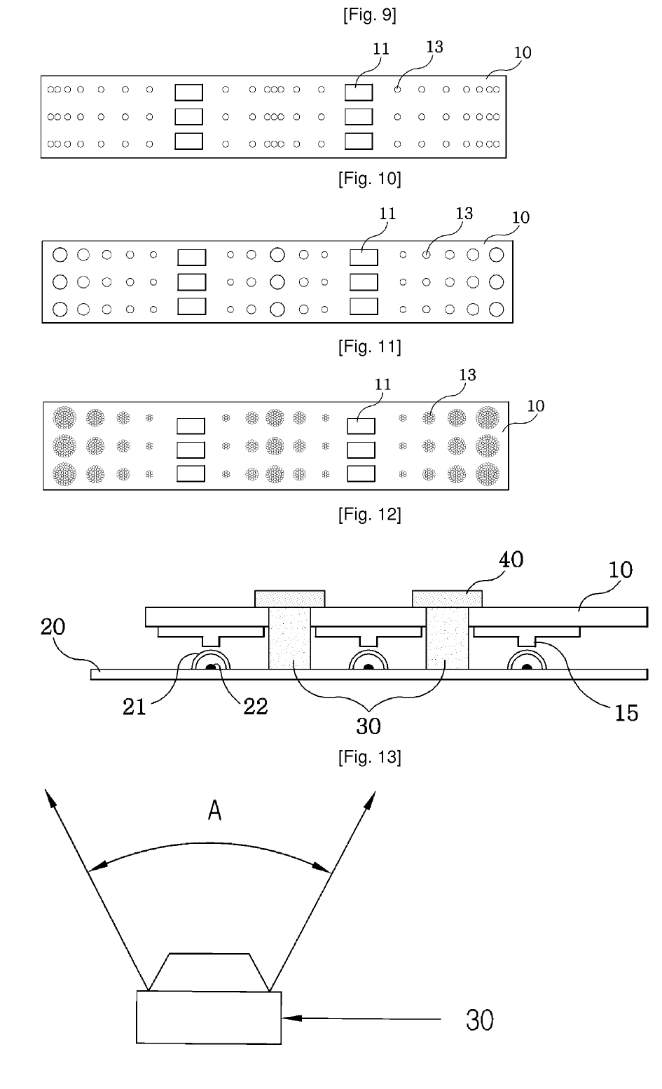

FIGS. 9 to 11 are plan views showing other examples of a pattern (13) of a light guide film (10) for use in a light emitting keypad of the present invention. As shown in the figures, it is preferred that a pattern be formed such that the pattern has a density increasing as the pattern goes far away from light sources, so as to provide a uniform light emitting surface. That is, since the amount of light supplied from the light sources is reduced as the pattern goes away from the light sources, the density of the pattern is increased so that light can be scattered much more, thereby obtaining a more uniform light emitting surface. The density of the pattern may be controlled by adjusting an interval of the pattern, i.e., a pitch of the pattern (FIG. 9). Alternatively, the density of the pattern may be controlled by adjusting the size of the pattern (FIG. 10). On the other hand, an intensive light emitting surface may be provided instead of a uniform light emitting surface by aggregating patterns densely in specific regions to provide more light emission to predetermined regions, e.g., character regions on a keypad (FIG. 11).

The shape of the pattern (13) is not limited to a particular shape and the present invention includes patterns formed through machining or printing on a surface of a light guide film. Although there is no limitation on a method of forming a pattern, the pattern is preferably formed by any one processing method of a hot stamping method of heating a patterned mold and pressing a light guide film against the mold to transfer the pattern to the light guide film, injection molding, micro blast, and laser. In addition, the pattern may be formed by means of silk printing using an ink containing a light-scattering material on the light guide film.

FIG. 12 is a sectional view of a light emitting keypad according to a further embodiment of the present invention. As shown in the figure, the protrusions (15) may be formed to correspond to the metal domes (21) in order to press the metal domes on the back surface of the light guide film (10) rather than the back surface of the key plate (1). The shape and manufacturing method of the protrusions are based on the above descriptions. Since the protrusions are formed on a lower portion of the light guide film, it is possible to eliminate a possibility that the light guide film may be pressed and deformed by the protrusions.

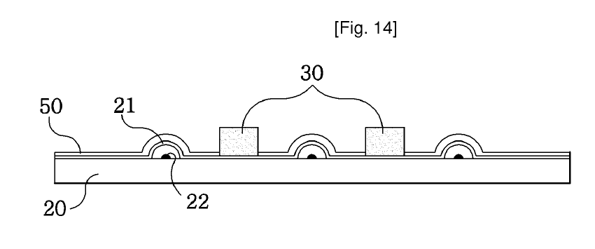

FIG. 14 is a partial sectional view of a light emitting keypad according to a further embodiment of the present invention. As shown in the figure, the light emitting keypad is characterized in that a reflection layer (50) is formed on all or a portion of an upper surface of a substrate (20). The reflection layer also includes the aforementioned reflection sheet. Since the reflection layer is disposed on the substrate, it is possible to improve the luminance of the light emitting keypad by reducing light loss that may be generated in the substrate. In the meantime, although the metal domes may be formed separately, the metal domes are preferably formed of an integrally manufactured dome substrate. This can be equally applied to the aforementioned embodiments.

Furthermore, the present invention provides a lower structure for the light emitting keypads shown by way of example in FIGS. 3 to 6, 12 and 14. That is, the present invention provides a lower structure for a light emitting keypad, comprising a substrate (20) provided with metal domes (21); a plurality of top view type light sources (30) disposed on the substrate; and a light guide film (10) disposed above the light sources so that light can be incident into and guided in the light guide film and then surface-emitted. All the features of the aforementioned components may be applied to respective components of the lower structure. Since these features have been sufficiently described, a repeated description thereof will be omitted.

Since the aforementioned embodiments are not for limiting the present invention but for specifically describing the present invention, changes, modifications and elimination made thereto within the technical spirit of the present invention are included in the scope of the present invention defined by the appended claims.

### INDUSTRIAL APPLICABILITY

The light emitting keypad according to the present invention can be properly used f or keypads of mobile phones and the like.

1. A light emitting keypad comprising:
a key plate with a plurality of keys formed thereon;
a light guide film formed below the key plate so that light can be incident into and guided in the light guide film and then surface-emitted;
a plurality of top view type light sources disposed below the light guide film; and
a substrate disposed below the light guide film and having metal domes.

2. The light emitting keypad as claimed in claim 1, wherein all or some of the light sources have a light emission angle in a range of 60° to 180°.

3. The light emitting keypad as claimed in claim 1, wherein through-holes are formed in regions of the light guide film corresponding to light sources so that the light from the light sources can be incident into the light guide film.

4. The light emitting keypad as claimed in claim 3, wherein a coupling member formed of at least one selected from a reflection layer, a translucent layer and a transparent layer is formed above each of the through-holes of the light guide film.

5. The light emitting keypad as claimed in claim 1, wherein protrusions are formed on a bottom surface of the light guide film to correspond to the metal domes in order to press the metal domes.

6. The light emitting keypad as claimed in claim 1, wherein a reflection layer capable of being in contact with or spaced apart from the light guide film is formed on a lower portion of the light guide film.

7. The light emitting keypad as claimed in claim 6, wherein the reflection layer is formed of a reflection sheet and attached to one side end, both side ends or the entire of a back surface of the light guide film using a double-sided tape.

8. The light emitting keypad as claimed in claim 6, wherein the reflection layer comprises at least one selected from the group consisting of silver (Ag), titanium dioxide (TiO2), zinc oxide (ZnO), barium sulfate (BaSO4), zinc sulfide (ZnS), lead white and antimony oxide (SbO).

9. The light emitting keypad as claimed in claim 1, wherein on at least one of front and back surfaces of the light guide film, a pattern is formed such that the pattern has a density increasing as the pattern goes far away from light sources, so as to uniformly supply light to the keypad, or patterns are locally formed in specific regions of the light guide film so that light is intensively supplied to predetermined regions of the keypad.

10. The light emitting keypad as claimed in claim 9, wherein the pattern is formed by means of at least one processing method of hot stamping, injection molding, micro blast and laser.

11. The light emitting keypad as claimed in claim 9, wherein the pattern is formed by means of silk printing using an ink containing a light-scattering material on the light guide film.

12. The light emitting keypad as claimed in claim 9, wherein the density of the pattern is adjusted by at least one method selected from interval adjustment and size adjustment of the pattern.

13. The light emitting keypad as claimed in claim 1, wherein the key plate is a flat key plate having the keys expressed and identified with colors.

14. The light emitting keypad as claimed in claim 4, wherein the reflection layer is formed on all or a portion of an upper surface of the substrate.

15. A lower structure for a light emitting keypad, comprising:
a substrate provided with metal domes;
a plurality of top view type light sources disposed on the substrate; and
a light guide film disposed above the light sources so that light can be incident into and guided in the light guide film and then surface-emitted.
